(19) United States
(12) Patent Application Publication
(10) Pub. No.: US 2025/0172904 A1
(43) Pub. Date: May 29, 2025

(54) IMAGE FORMING APPARATUS AND CONTRACT SYSTEM FOR IMAGE FORMING APPARATUS

(71) Applicant: CANON KABUSHIKI KAISHA, Tokyo (JP)

(72) Inventors: EIICHIRO TESHIMA, Kanagawa (JP); TAKUYA HAYATO, Kanagawa (JP)

(21) Appl. No.: 18/959,286

(22) Filed: Nov. 25, 2024

(30) Foreign Application Priority Data
Nov. 29, 2023 (JP) 2023-201641

(51) Int. Cl. G03G 21/18; G03G 15/00

(52) U.S. Cl. CPC G03G 21/1853; G03G 15/5016; G03G 15/556; G03G 21/1882; G03G 21/1892

(57) ABSTRACT

An apparatus includes a lock member of a door that restricts, in a state in which a plurality of cartridges detachable from the apparatus is attached, removal of the plurality of consumable units from the apparatus. In a state in which a subscription contract of using a specific cartridge delivered from a service provider is made, in a case where at least one of the attached cartridges is the specific cartridge, the apparatus brings the lock member into a locked state, and when a predetermined unlock condition is satisfied, clears the locked state.

### BACKGROUND

### Technical Field

The aspect of the embodiments relates to an image forming apparatus and a contract system for an image forming apparatus.

### Description of the Related Art

There is a known technique of using a consumable unit until its operating life in an image forming apparatus with the detachable consumable unit, such as a toner container or a process cartridge including a toner container, attached on. The use up of the consumable unit until its operating life reduces the replacement frequency of the consumable unit.

Japanese Patent Application Laid-Open No. 2005-091462 discusses a technique of making a process cartridge detachable by setting a stopper for the process cartridge to disabled (unlocked) only when the replacement timing of the process cartridge is detected. Japanese Patent Application Laid-Open No. 2011-008142 discusses a technique of locking a cover of a toner container, displaying a replacement screen for a toner container when a no toner state of the toner container is detected, and unlocking the cover corresponding to the toner container, with an input via the replacement screen. In this manner, there have been known techniques of restricting removal of a consumable unit, such as a process cartridge or a toner container, from the image forming apparatus until its operating life.

On the other hand, some service providers a print service of sending dedicated cartridges (process cartridges) with a fixed fee or a page-basis fee to be charged on the image formation executed using the cartridge. In recent years, contract systems have spread for image forming apparatuses with flat-rate subscription print services.

In these contract systems, a door-lock can be made in a state in which a dedicated cartridge provided from a service provider and other cartridges are attached together. In this case, it is desirable to use the dedicated cartridge in terms of cost.

### SUMMARY

According to an aspect of the embodiments, an apparatus to which a plurality of cartridges to be used in image formation on a recording material is attachable includes a lock member configured to lock the plurality of cartridges attached from being removed, and a control unit configured to switch a state of the lock member between a locked state in which the plurality of cartridges is locked from being removed and an unlocked state in which the lock of the plurality of cartridges from being removed is cleared. In a contract state in which a contract of using a specific cartridge delivered from a service provider is made, in a case where at least one of the plurality of cartridges attached is the specific cartridge, the control unit switches the state of the lock member to the locked state, and based on satisfaction of a predetermined unlock condition, switches the state of the lock member to the unlocked state.

Further features of the disclosure will become apparent from the following description of exemplary embodiments with reference to the attached drawings.

### BRIEF DESCRIPTION OF THE DRAWINGS

FIG. 1 is a cross-sectional view illustrating an example of the hardware configuration of an image forming apparatus.

FIGS. 2A and 2B are schematic perspective views illustrating an example of a configuration related to the attachment and detachment of a cartridge.

FIGS. 3A and 3B are schematic cross-sectional views illustrating a configuration example of a lock mechanism and an open/close detection mechanism for a door.

FIG. 4 is a block diagram illustrating an example of the hardware configuration of the image forming apparatus.

FIG. 5 is a block diagram illustrating an example of a control configuration of the image forming apparatus.

FIG. 6 is a sequence diagram illustrating an example of a sequence of processing related to a subscription contract.

FIG. 7 is a flowchart illustrating an example of a processing procedure for executing unlocking of a door.

FIG. 8 is a sequence diagram illustrating an example of a sequence of processing to be executed when a remaining toner amount is low (second exemplary embodiment).

FIG. 9 is a flowchart illustrating an example of a processing procedure for executing unlocking of a door (second exemplary embodiment).

FIG. 10 is a sequence diagram illustrating an example of a sequence of processing to be executed when a remaining toner amount is low (second example of second exemplary embodiment).

FIGS. 11A to 11D are diagrams illustrating examples of information stored in a cartridge memory and a main body memory.

### DESCRIPTION OF THE EMBODIMENTS

Hereinafter, exemplary embodiments will be described in detail with reference to the accompanying drawings. The following exemplary embodiments are not intended to limit the disclosure set forth in the appended claims. Although a plurality of features is described in the exemplary embodiments, not all the plurality of features are always essential to the disclosure. In addition, the plurality of features can be arbitrarily combined. Furthermore, in the accompanying drawings, the same or similar components are assigned the same reference numerals, and the redundant description will be omitted.

As an example of an image forming apparatus according to an exemplary embodiment of the present disclosure, an electrophotographic laser beam printer (LBP) will be described. However, the image forming apparatus is not limited to an LBP, and may be an image forming apparatus of another type, such as a copier, a facsimile apparatus, or an inkjet printer.

### Image Forming Apparatus

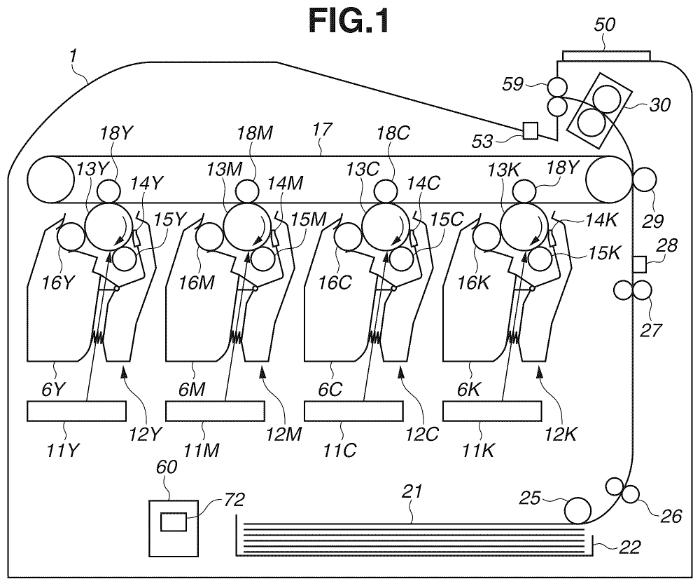

FIG. 1 is a cross-sectional view illustrating a schematic hardware configuration example of an image forming apparatus 1 according to a first exemplary embodiment. The image forming apparatus 1 is configured to perform an image formation on a recording material using an electrophotographic method. The image forming apparatus 1 is also configured to form a full-color image as superimposed yellow, magenta, cyan, and black toner images. The image forming apparatus 1 according to the present exemplary embodiment employs an intermediate transfer method, but may be a laser beam printer that employs a direct transfer method of transferring a toner image to a recording material from a photosensitive member (photosensitive drum) not via an intermediate transfer member (intermediate transfer belt).

The image forming apparatus 1 includes laser scanners 11Y, 11M, 11C, and 11K, and process cartridges (cartridges) 12Y, 12M, 12C, and 12K detachably attached to the image forming apparatus 1. The alphabetical letters Y, M, C, and K added to the reference numerals indicate toner colors corresponding to yellow (Y), magenta (M), cyan (C), and black (K), and are omitted when the details common to the colors are described. In the image forming apparatus 1, the laser scanner 11Y and the cartridge 12Y constitute an image forming unit for forming yellow (Y) toner images, and the same applies to the other image forming units corresponding to magenta (M), cyan (C), and black (K).

The cartridge 12 includes a photosensitive drum 13, a drum cleaner 14, a charging roller 15, a development roller 16, a toner container 6, and a remaining toner amount sensor 62. The cartridge 12 is an example of a consumable unit that is detachable from the image forming apparatus 1, and to be used for image formation on a recording material. In the present exemplary embodiment, an example in which the consumable unit is a process cartridge (the cartridge 12) will be described, but the consumable unit is not limited to this. For example, a consumable unit that is detachable from the image forming apparatus 1 and to be used for image formation on a recording material may be a toner container storing toner.

In the cartridge 12, the photosensitive drum 13 is an image bearing member that bears an electrostatic latent image and a toner image formed through a development of the electrostatic latent image with toner. The photosensitive drum 13 is driven to rotate at a predetermined circumferential velocity in a direction indicated by arrows illustrated in FIG. 1. The drum cleaner 14 is arranged in contact with the photosensitive drum 13. An intermediate transfer belt 17 is arranged at a position where the intermediate transfer belt 17 is in contact with the photosensitive drums 13Y, 13M, 13C, and 13K. In addition, primary transfer rollers 18Y, 18M, 18C, and 18K are arranged at positions where the primary transfer rollers 18Y, 18M, 18C, and 18K face the photosensitive drums 13Y, 13M, 13C, and 13K via the intermediate transfer belt 17, respectively.

The charging roller 15 uniformly changes the surface of the photosensitive drum 13. The laser scanner 11 emits laser light modulated based on image signals (image data) to the photosensitive drum 13 to form an electrostatic latent image on the surface of the photosensitive drum 13. The development roller 16 develops the electrostatic latent image formed on the photosensitive drum 13 with toner (developer) supplied from the toner container 6 to form a toner image on the photosensitive drum 13.

The toner image formed on the photosensitive drum 13 is transferred onto the intermediate transfer belt 17 by a primary transfer roller 18 at a transfer position (primary transfer portion). At this time, the four toner images that are the yellow (Y), magenta (M), cyan C, and black (K) toner images respectively formed on the photosensitive drums 13Y, 13M, 13C, and 13K are sequentially transferred onto the intermediate transfer belt 17 in a superimposing manner. As the rotation of the intermediate transfer belt 17, the toner image formed on the intermediate transfer belt 17 is conveyed to a secondary transfer portion being a contact portion between the intermediate transfer belt 17 and a secondary transfer roller 29. At the secondary transfer portion, the toner image on the intermediate transfer belt 17 is transferred to a sheet (sheet) 21 conveyed on a conveyance path from a cassette (storage portion) 22.

The cassette 22 is stored with the sheets 21 stacked in it. On the conveyance path for conveying a sheet 21 from the cassette 22 to the secondary transfer portion, a sheet feeding roller 25, a conveyance roller 26, a registration roller 27, and a registration sensor 28 are arranged. A sheet 21 in the cassette 22 is fed by the sheet feeding roller 25 to the conveyance path, and conveyed by the conveyance roller 26 on the conveyance path toward the registration roller 27.

The sheet 21 conveyed to the registration roller 27 is conveyed by the registration roller 27 at a predetermined control timing to the secondary transfer portion at a conveyance speed corresponding to the rotational speed of the intermediate transfer belt 17. At the secondary transfer portion, the toner image on the intermediate transfer belt 17 is transferred by the secondary transfer roller 29 onto the sheet 21.

A fixing device 30 and a discharge roller 59 are disposed downstream of the secondary transfer roller 29 in a conveyance direction of the sheet 21. In addition, a sheet sensor 53 for detecting the sheet 21 discharged onto a discharge tray is provided near the discharge roller 59. The sheet 21 bearing the toner image transferred by the secondary transfer roller 29 is conveyed to the fixing device 30. The fixing device 30 includes a fixing roller serving as a heating member, and a pressing roller serving as a pressing member that is arranged facing the fixing roller. The fixing device 30 performs fixing processing of fixing the transferred toner image to the sheet 21 by applying heat and pressure to the sheet 21 using the fixing roller and the pressing roller. The sheet 21 subjected to the fixing processing is discharged onto the discharge tray by the discharge roller 59.

The image forming apparatus 1 further includes an operation panel 50 and a control unit (control board) 60. The control unit 60 includes a main body memory 72. At the time of factory shipment, for example, model information about the image forming apparatus 1 is prestored in the main body memory 72. The operation panel 50 includes a display unit for display information to the user (notifying the user of information), and an input unit that receives an input of information by receiving an operation of the user.

### Configuration Related to Attachment and Detachment of Cartridge

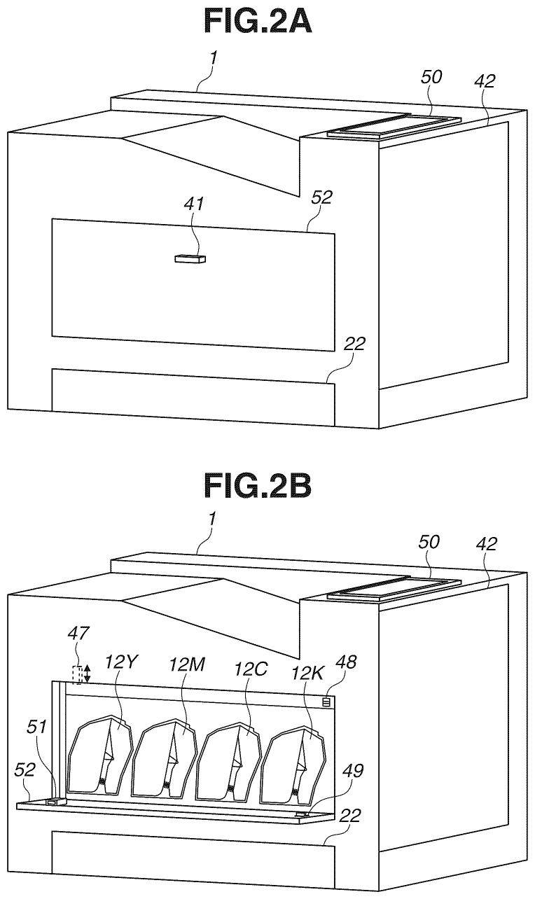

FIGS. 2A and 2B are schematic perspective views illustrating an example of a configuration related to the attachment and detachment of the cartridge 12 in the image forming apparatus 1 according to the present exemplary embodiment. FIG. 2A illustrates a case where a door 52 provided in the main body of the image forming apparatus 1 is in a closed state. FIG. 2B illustrates a case where illustrates a case where the door 52 is in an opened state.

The door 52 is configured to enable access to a consumable unit (the cartridge 12) attached to (the inside of) the image forming apparatus 1, in the opened state, and disable the access in the closed state. The main body of the image forming apparatus 1 is provided with one door 52 for all the cartridges 12. The door 52 is provided with an operation member 41 to be used by the user for performing an open/close operation of the door 52. With the door 52 in the opened state, the cartridge 12 can be attached to the inside of (the main body of) the image forming apparatus 1, and be removed from the inside of (the main body of) the image forming apparatus 1.

After a brand-new unit (the cartridge 12, etc.) is attached to the image forming apparatus 1, if the unit is used for a certain period of time and a replacement timing eventually comes, the unit will be replaced with another brand-new unit. The replacement timing corresponds to a timing at which predetermined image quality becomes unable to be maintained in a case where image formation is performed using an attached unit, for example, and will also be referred to as an “operating life” in this specification.

The image forming apparatus 1 according to the present exemplary embodiment further includes a door 42 provided as a door for enabling access to the inside of the main body. By opening the door 42, user's access to the conveyance path is enabled. The door 42 is used for the user to access a conveyance path and remove the sheet 21 stuck on the conveyance path in a case where a jam occurs in the sheet 21 being conveyed, for example.

As illustrated in FIG. 2B, the image forming apparatus 1 includes a lock pin 47, and a lock member 51 that is arranged on the door 52 and becomes paired with the lock pin 47. The lock pin 47 is configured to restrict the movement of the door 52 from the closed state to the opened state. The lock member 51 is arranged at a position where the lock pin 47 and the lock member 51 fit with each other in a case where the door 52 is in the closed state. The image forming apparatus 1 further includes a door sensor 48 being a sensor for detecting the opened/closed state of the door 52, and a member 49 to be used to detect the opened/closed state of the door 52 using the door sensor 48.

In the present exemplary embodiment, the lock pin 47 and the lock member 51 constitute a lock mechanism that locks the door 52 in the closed state. The lock pin 47 and the lock member 51 serve as an example of a restriction unit that restricts the removal of a consumable unit from the image forming apparatus 1 with the consumable unit being attached to the image forming apparatus 1.

### Lock Mechanism and Open/Close Detection Mechanism of Door

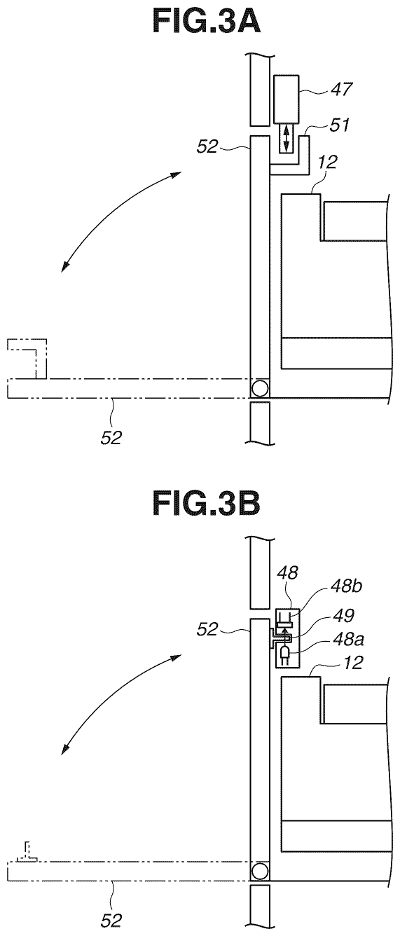

FIG. 3A is a schematic cross-sectional view illustrating a configuration example of a lock mechanism of the door 52 in the image forming apparatus 1 according to the present exemplary embodiment. As illustrated in FIG. 3A, the lock pin 47 fits with the lock member 51 by entering a protruding state by partially protruding toward the inside of the lock member 51. By the lock pin 47 and the lock member 51 fitting with each other, the door 52 is fixed in the closed state by the lock pin 47. This restricts (prohibits) the removal of the cartridge 12 from the inside of the image forming apparatus 1 that is to be performed by the user.

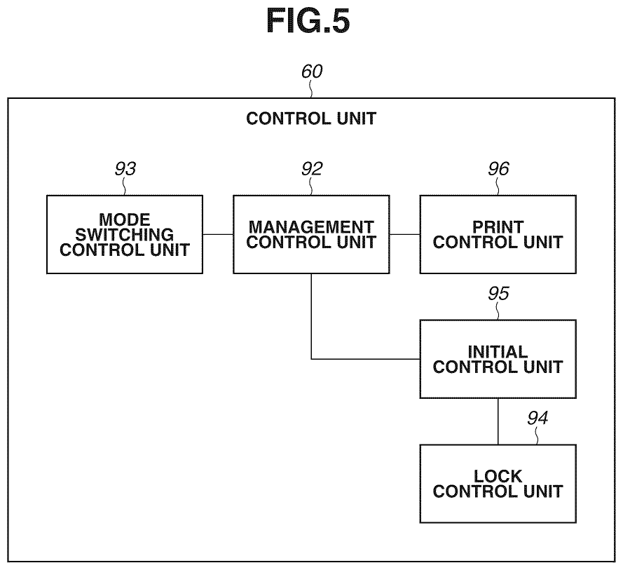

The operation of the lock pin 47 is controlled by a lock control unit 94 (FIG. 5) to be described below. The state of the lock pin 47 is switched between a state in which the door 52 can be brought into the opened state (as indicated by broken lines in FIG. 3A) and a state in which the door 52 is fixed in the closed state (as indicated by solid lines in FIG. 3A).

FIG. 3B is a schematic cross-sectional view illustrating a configuration example of a detection mechanism that detects the open/close of the door 52. As described above, the detection of the opened/closed state of the door 52 is performed using the door sensor 48. As an example, the door sensor 48 includes a photointerrupter. The door sensor 48 includes a light emission unit 48a that emits light, and a light receiving unit 48b that receives light emitted from the light emission unit 48a.

The opened/closed state of the door 52 is detected based on the output of the light receiving unit 48b. If the state of the door 52 switches from the opened state to the closed state, the member 49 is inserted between the light emission unit 48a and the light receiving unit 48b in the door sensor 48. Light emitted from the light emission unit 48a is accordingly shielded by the member 49 and stops being received by the light receiving unit 48b. In this case, the door sensor 48 outputs a detection result indicating that the closed state of the door 52 is detected.

On the other hand, if the state of the door 52 switches from the closed state to the opened state, the member 49 enters a state of not being inserted between the light emission unit 48a and the light receiving unit 48b in the door sensor 48. Light emitted from the light emission unit 48a is accordingly received by the light receiving unit 48b while the member 49 does not shield the light. In this case, the door sensor 48 outputs a detection result indicating that the opened state of the door 52 is detected. A signal (information) indicating a detection result of the opened/closed state of the door 52 that is output from the door sensor 48 is output to the control unit 60 (the lock control unit 94 (FIG. 5)).

### Hardware Configuration

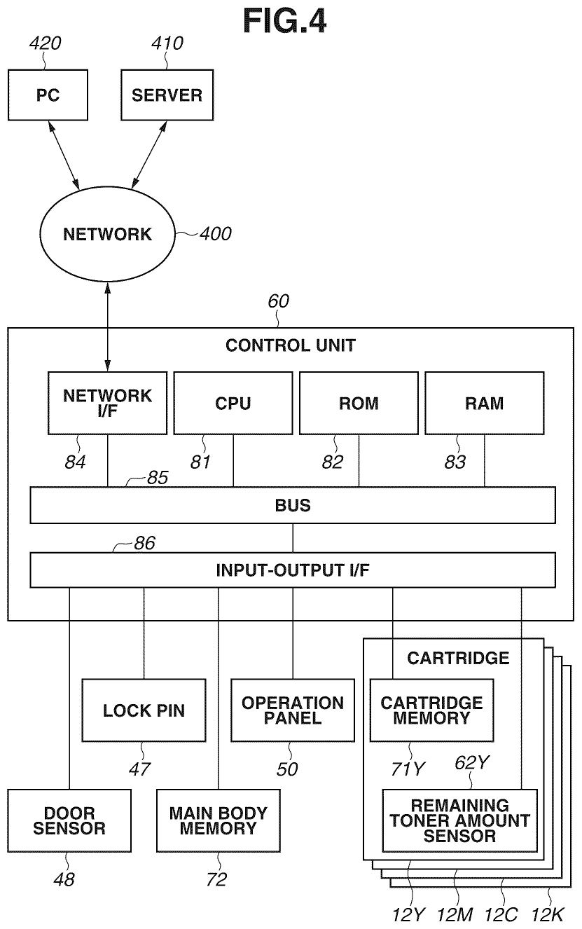

FIG. 4 is a block diagram illustrating a hardware configuration example of the image forming apparatus 1 according to the present exemplary embodiment.

The image forming apparatus 1 includes the control unit 60. The control unit 60 includes a central processing unit (CPU) 81, a read-only memory (ROM) 82, a random access memory (RAM) 83, a bus 85, an input-output interface (I/F) 86, and a network I/F 84. The control unit 60 is formed as a control board on which these devices are mounted (integrated) as components, for example. The devices in the control unit 60 is connected to each other via the bus 85, enabling bidirectional communication.

The CPU 81 generally controls the operations of the image forming apparatus 1 by reading programs stored in the ROM 82, and executing the programs. The CPU 81 uses a storage area of the RAM 83 as a work area. The CPU 81 can access the network I/F 84 and the input-output I/F 86 via the bus 85.

The lock pin 47, the door sensor 48, the main body memory 72, and the operation panel 50 are connected to the input-output I/F 86. With the cartridges 12 (12Y, 12M, 12C, and 12K) attached to the image forming apparatus 1, cartridge memories 71 (71Y, 71M, 71C, and 71K) in the cartridges 12 are connected to the input-output I/F 86. In addition, the remaining toner amount sensors 62 (62Y, 62M, 62C, and 62K) are similarly connected to the input-output I/F 86 in a case where the cartridges 12 (12Y, 12M, 12C, and 12K) are attached to the image forming apparatus 1. The CPU 81 controls the devices connected to the input-output I/F 86, via the input-output I/F 86. Devices other than the devices illustrated in FIG. 4 may be connected to the input-output I/F 86. The remaining toner amount sensors 62Y, 62M, 62C, and 62K detect remaining toner amounts in the toner containers 6Y, 6M, 6C, and 6K, respectively.

The network I/F 84 is connected to a network 400 including a local area network (LAN) and the internet. Using the network I/F 84, the CPU 81 can communicate with external devices accessible via the network 400. In the present exemplary embodiment, the CPU 81 can communicate with a server 410 and a personal computer (PC) 420 via the network 400. The PC 420 is a terminal apparatus to be operated by the user. The server 410 can communicate with the image forming apparatus 1 via the network 400, and is managed by a service provider.

### Control Configuration

FIG. 5 is a block diagram illustrating a control configuration example of the image forming apparatus 1 according to the present exemplary embodiment. As functional units to be implemented on the control unit 60 (the CPU 81), the image forming apparatus 1 includes a management control unit 92, a mode switching control unit 93, the lock control unit 94, an initial control unit 95, and a print control unit 96. Each of these functional units can be implemented on the control unit 60 (the CPU 81) by the CPU 81 reading programs stored in the ROM 82, and executing the programs.

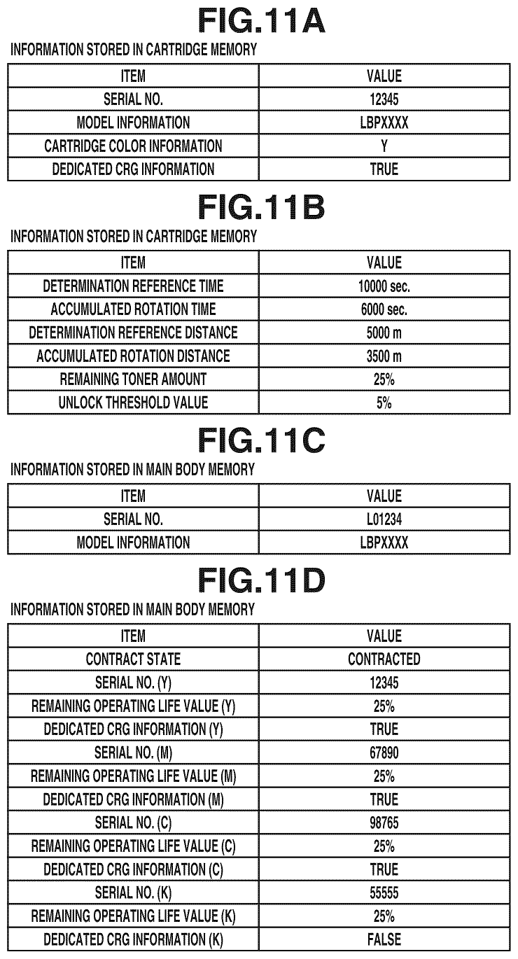

The mode switching control unit 93 performs a control of switching a contract state of the image forming apparatus 1 as for a service provided by a service provider, between an uncontracted state (“uncontracted”) and a contracted state (“contracted”) based on a notification received from the server 410. In accordance with the switching of the contract state, the mode switching control unit 93 updates information stored in the main body memory 72 (contract state to be described below with reference to FIG. 11D). In the present exemplary embodiment, the contracted state (“contracted”) is an example of a first state in which the contract is made for a service to be executed using a specific type of a consumable unit (dedicated cartridge) that is provided by a service provider. In addition, the uncontracted state (“uncontracted”) is an example of a second state in which the above-described contract is not made.

The management control unit 92 performs a control of managing the operation of each unit related to a print operation. The print control unit 96 performs a control related to an image formation operation (print operation) of the image forming apparatus 1. The print control unit 96 performs, for example, the drive control of various rollers (the sheet feeding roller 25 and the conveyance roller 26, etc.) to be used for feeding and conveyance of the sheet 21, and the output control of high voltage (charge voltage, development voltage, and transfer voltage, etc.) from a high-voltage power source. The print control unit 96 further performs the drive control of a scanner motor included in the laser scanner 11, light emission control of a laser light source included in the laser scanner 11, and temperature control of the fixing device 30.

The lock control unit 94 controls the operation of the lock pin 47 (the lock mechanism of the door 52), and performs the management of information and operating life of the cartridges 12. In addition, the lock control unit 94 performs determination regarding a condition for locking the door 52, and a condition for cancelling a locked state, and controls the operation of the lock pin 47 in accordance with a determination result. The lock control unit 94 is configured to perform control of switching the state of the lock mechanism of the door 52 between a restriction state (locked state) in which the removal of the cartridge 12 is restricted, and a non-restriction state (unlocked state) in which the removal of the consumable unit is not restricted.

When the power of the image forming apparatus 1 is turned on or the door 52 is closed, the initial control unit 95 performs initial processing, such as processing of detecting remaining paper on a conveyance path in the image forming apparatus 1.

### Example of Information Stored in Memory

Next, an example of information stored in the cartridge memory 71 and the main body memory 72 will be described with reference to FIGS. 11A to 11D. FIGS. 11A and 11B illustrate an example of information stored in the cartridge memory 71Y. In this example, an example of information stored in the cartridge memory 71Y corresponding to yellow is illustrated. The same applies to the cartridges 12M, 12C, and 12K. FIGS. 11C and 11D illustrate an example of information stored in the main body memory 72.

FIG. 11A illustrates an example of information unique to the cartridge 12Y that is stored in the cartridge memory 71Y. The information illustrated in FIG. 11A is information unique to the cartridge 12Y that is set at the time of factory shipment of the image forming apparatus 1, and not to be updated by the lock control unit 94.

A serial number (serial No.) is an identification number uniquely allocated to the cartridge 12Y. Model information indicates a model number of the image forming apparatus 1 in which the cartridge 12Y is used. Cartridge color information indicates a toner color corresponding to the cartridge 12Y, and indicates yellow (Y), magenta (M), cyan (C), or black (K). Dedicated CRG (cartridge) information indicates whether the cartridge 12Y is dedicated to a service provided by a service provider. As an example, if the cartridge 12Y is a cartridge dedicated to a service, the dedicated CRG information includes “TRUE”, and if the cartridge 12Y is not a dedicated cartridge (is a normal cartridge), the dedicated CRG information includes “FALSE”. In the present exemplary embodiment, the dedicated cartridge is an example of a specific type of a consumable unit provided from a service provider.

In the example in FIG. 11A, in the cartridge memory 71Y corresponding to yellow, “12345” is stored as a serial number, “LBPXXXX” is stored as model information, “Y” is stored as cartridge color information, and “TRUE” is stored as dedicated CRG information. The dedicated CRG information is an example of information indicating whether the cartridge 12 is a dedicated cartridge (specific type of consumable unit). Based on information stored in the cartridge memory 71 included in the cartridge 12 (consumable unit) attached to the image forming apparatus 1, the lock control unit 94 can determine whether the cartridge is a dedicated cartridge (specific type of consumable unit).

FIG. 11B illustrates an example of information related to the operating life of the cartridge 12Y that is stored in the cartridge memory 71Y. The accumulated rotation time of the corresponding photosensitive drum 13Y, and the determination reference time to be used to determine the remaining operating life of the photosensitive drum 13Y based on the accumulated rotation time are stored in the cartridge memory 71Y. The accumulated rotation time of the photosensitive drum 13Y is an accumulated time obtained by accumulating times during which the photosensitive drum 13Y has performed rotation operations. The accumulated rotation time stored in the cartridge memory 71Y is updated as appropriate during the rotation operation of the photosensitive drum 13. The determination reference time is a time predefined as an accumulated rotation time of the photosensitive drum 13Y at which the photosensitive drum 13Y reaches its operating life.

Using values of the determination reference time and the accumulated rotation time that are stored in the cartridge memory 71, the lock control unit 94 acquires the remaining operating life value based on the accumulated rotation time of the photosensitive drum 13Y. For example, as illustrated in FIG. 11B, if the determination reference time of the photosensitive drum 13Y is set to 10000 sec., and the accumulated rotation time is set to 6000 sec., 6000/10000×100=60[%] as the amount of the photosensitive drum 13Y used. This corresponds to the ratio of the accumulated rotation time to the determination reference time. In addition, the remaining operating life value based on the accumulated rotation time of the photosensitive drum 13Y is 40% (=100%-60%).

Furthermore, the accumulated rotation distance of the photosensitive drum 13Y, and the determination reference distance to be used to determine the remaining operating life of the photosensitive drum 13Y based on the accumulated rotation distance are stored in the cartridge memory 71Y. The accumulated rotation distance of the photosensitive drum 13Y is obtained by accumulating the distances of movement of the surface of the photosensitive drum 13Y by the rotation of the photosensitive drum 13Y. The accumulated rotation distance stored in the cartridge memory 71Y is updated as appropriate during the rotation of the photosensitive drum 13. The determination reference distance is pre-defined as the accumulated rotation distance of the photosensitive drum 13Y at which the photosensitive drum 13Y reaches its operating life.

Using values of the determination reference distance and the accumulated rotation distance stored in the cartridge memory 71, the lock control unit 94 acquires the remaining operating life value related to the rotation distance of the photosensitive drum 13Y.

For example, as shown in FIG. 11B, when the determination reference distance of the photosensitive drum 13Y is set to 5000 m and the accumulated rotation distance is set to 3500 m, the amount of the photosensitive drum 13Y used corresponds to the ratio of the accumulated rotation distance to the determination reference distance, and is obtained as 3500/5000×100=70[%]. In addition, the remaining operating life value based on the accumulated rotation distance of the photosensitive drum 13Y is 30% (=100%-70%).

Furthermore, the remaining toner amount in the toner container 6Y detected by the remaining toner amount sensor 62Y is stored in the cartridge memory 71Y. The remaining toner amount is updated as appropriate based on the detection made by the remaining toner amount sensor 62Y. The remaining toner amount can be acquired using a method other than the method of using the remaining toner amount sensor 62Y, such as a method of acquiring the remaining toner amount based on the integration value of the number of pixels of images formed by the laser scanner 11Y, for example.

In the foregoing description, the remaining operating life value of the photosensitive drum 13Y based on the accumulated rotation time, the remaining operating life value of the photosensitive drum 13Y based on the accumulated rotation distance, and the remaining toner amount can be used as a remaining operating life value indicating the remaining operating life of the cartridge 12Y. In the present exemplary embodiment, as an example, the lock control unit 94 acquires the smallest value of these three values, and stores the value into the main body memory 72 as a remaining operating life value indicating the remaining operating life of the cartridge 12Y (consumable unit). In the example illustrated in FIG. 11B, the remaining operating life value of the photosensitive drum 13Y based on the accumulated rotation time is 40%, and the remaining operating life value of the photosensitive drum 13Y based on the accumulated rotation distance is 30%, and the remaining toner amount is 25%. In this case, the lock control unit 94 determines that the remaining operating life value of the cartridge 12Y to be 25%, and stores the determined remaining operating life value into the main body memory 72.

The lock control unit 94 can determine the remaining operating life value indicating the remaining operating life of the cartridge 12Y based on the remaining operating life value of the photosensitive drum 13Y based on the accumulated rotation time, the remaining operating life value of the photosensitive drum 13Y based on the accumulated rotation distance, or the remaining toner amount in the foregoing description. Besides, another index value related to the operating life of the cartridge 12 can be used as the remaining operating life value of the cartridge 12Y. In this manner, the lock control unit 94 (the control unit 60) uses the following information when acquiring the remaining operating life value. For example, the information is an accumulated time obtained by accumulating the times of rotation of the photosensitive member (the photosensitive drum 13). Further, the information is an accumulated distance obtained by accumulating the distances of movement of the surface of the photosensitive member by its rotations. Furthermore, the information is a remaining toner amount in the toner container. In other words, the remaining operating life value can be acquired based on one or more values of the above-described values. If a consumable unit detachable from the image forming apparatus 1 is a toner container, the remaining operating life value can be acquired based on the remaining toner amount in the toner container.

As illustrated in FIG. 11B, an unlock threshold value is further stored in the cartridge memory 71Y. The unlock threshold value is defined as a threshold value to be used to determine whether to clear the locked state of the door 52 caused by the lock mechanism based on the remaining operating life value of the cartridge 12Y. In the present exemplary embodiment, as described below, the lock control unit 94 performs a control of clearing the locked state of the door 52 in order to enable a replacement of the cartridge 12Y when the remaining operating life value of the cartridge 12Y reaches the unlock threshold value or less (in this example, 5% or less). The lock control unit 94 performs a similar control for the cartridges 12M, 12C, and 12K.

FIG. 11C illustrates an example of information unique to the image forming apparatus 1 stored in the main body memory 72. The information illustrated in FIG. 11C is unique to the image forming apparatus 1, is set at the time of factory shipment of the image forming apparatus 1, and is not to be updated by the lock control unit 94.

A serial number (serial No.) is an identification number uniquely allocated to the image forming apparatus 1. Model information indicates the model number of the image forming apparatus 1. In this example, in the main body memory 72, “L01234” is stored as the serial number, and “LBPXXXX” is stored as the model information.

FIG. 11D illustrates an example of information regarding the cartridge 12 stored in the main body memory 72. The information illustrated in FIG. 11D is updated as appropriate based on the use conditions of the image forming apparatus 1. A contract state indicates whether the contract of the image forming apparatus 1 is made (concluded) regarding a service provided by a service provider using dedicated cartridges. The contract state stored in the main body memory 72 is set to “contracted” if the service is contracted, and set to “uncontracted” if the service is not contracted (is uncontracted). In this manner, information indicating the contract state of the image forming apparatus 1 is stored in the main body memory 72.

Furthermore, information read from the cartridge memory 71 of each cartridge 12, and the remaining operating life value acquired based on the read information are stored in the main body memory 72. In this example, the serial number, the remaining operating life value, and the dedicated CRG information about each cartridge 12 are stored in the main body memory 72.

### Processing Sequence Regarding Subscription Contract

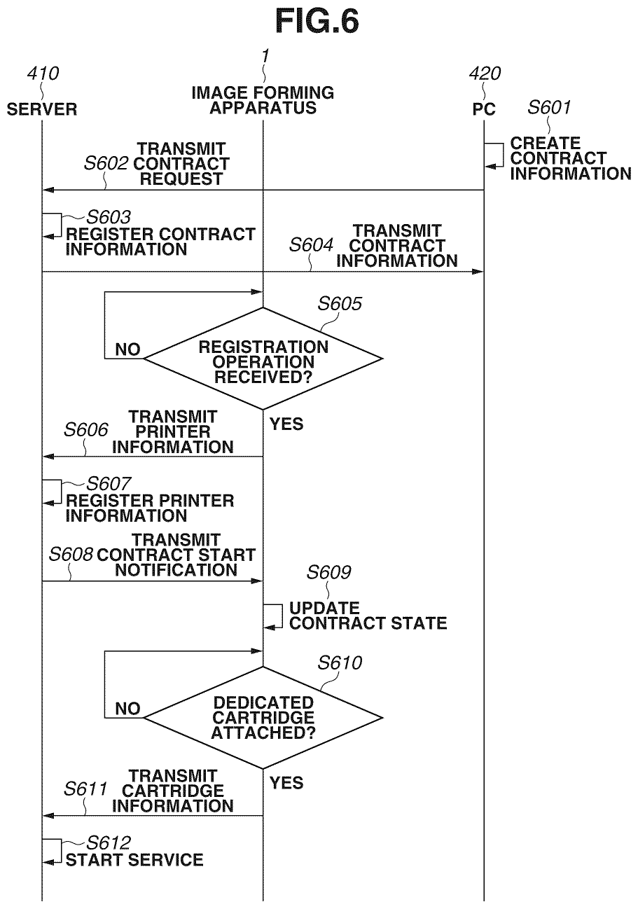

A processing sequence related to a subscription contract will now be described with reference to FIG. 6. In the present exemplary embodiment, a contract (subscription contract) of a service using a specific type of consumable unit provided by a service provider is made for the image forming apparatus 1.

As described above, in the present exemplary embodiment, a cartridge dedicated to the service is provided by the service provider as a specific type of consumable unit. Based on the contract, the service provider provides a print service based on a fixed fee or a page-basis fee to be charged on the image formations executed using the specific type of consumable unit.

First of all, in step S601, the PC 420 creates contract information for concluding a contract regarding the provision of the service to be provided by the service provider, based on an input made by the user. The user enters information via a website screen displayed on a display unit of the PC 420 by a web browser. This website screen is provided to the PC 420 from the server 410 managed by the service provider. The contract information created by the PC 420 includes, for example, a name, an address, a payment method, an e-mail address, and model information (e.g.: “LBPXXXX”) of an image forming apparatus (printer) to be used.

If the creation of contract information is completed, in step S602, the PC 420 transmits a contract request including the contract information, to the server 410. The communication between the PC 420 and the server 410 is performed via the network 400. After the creation of the contract information, for example, the PC 420 displays, by the web browser, a dialog box for finally asking the user whether to conclude a contract, and transmits a contract request upon an OK button being pressed on the dialog box.

If the server 410 receives the contract request from the PC 420, in step S603, the server 410 stores the contract information included in the received contract request into a nonvolatile memory (not illustrated) and performs the registration of the contract information. After that, in step S604, the server 410 transmits registration information for registration into the image forming apparatus 1 to the PC 420 as a response to the contract request. For example, the transmission of the registration information can be performed by the transmission of an e-mail addressed to an e-mail address included in the contract information. The registration information to be transmitted includes, for example, a notification indicating that the registration of contract information is complete, a procedure for starting the provision of the service, and a registration code (e.g.: “CD123456”) to be entered into the image forming apparatus 1. The registration code is stored into the nonvolatile memory in association with the contract information.

After the transmission of the registration information, a cartridge dedicated to a service based on the contract is sent by the service provider to a contractant as a user (the user of the PC 420 and the image forming apparatus 1). The service provider sends the dedicated cartridge to a destination indicated as an address included in the contract information.

In step S605, the image forming apparatus 1 receives, via the operation panel 50, a registration operation regarding the contract concluded with the service provider. By displaying an operation screen (operation menu) for the registration operation on the operation panel 50, the control unit 60 of the image forming apparatus 1 receives the registration operation performed by the user. In step S606, the image forming apparatus 1 transmits printer information to the server 410 based on the entry made by the registration operation. The printer information includes, for example, the serial number and the model information stored in the main body memory 72 of the image forming apparatus 1, the entered registration code, and the internet protocol (IP) address of the image forming apparatus 1. The communication between the image forming apparatus 1 and the server 410 is performed via the network 400.

If the server 410 receives the printer information from the image forming apparatus 1, in step S607, the server 410 checks whether the received printer information matches the contract information. Specifically, the server 410 refers to the contract information associated with the registration code included in the received printer information, and confirms that the model information included in the contract information and the model information included in the printer information are identical. If the printer information and the contract information are identical, the server 410 performs the registration of the printer information by storing the printer information into the nonvolatile memory in association with the contract information. If the registration of the printer information is completed, in step S608, the server 410 transmits, to the image forming apparatus 1, a contract start notification indicating the start of the contract of the provision of the service provided by the service provider (contract is concluded).

If the image forming apparatus 1 receives the contract start notification from the server 410, in step S609, the image forming apparatus 1 (the mode switching control unit 93) shifts the image forming apparatus 1 from the uncontracted state (second state) to the contracted state (first state) based on the notification. Furthermore, the image forming apparatus 1 (the mode switching control unit 93) updates information (contract state) stored in the main body memory 72 from “uncontracted” to “contracted”.

The user performs the above-described registration operation, and also attaches the dedicated cartridge delivered from the service provider to the image forming apparatus 1. If a cartridge (normal cartridge, etc.) of a type other than the dedicated cartridge is attached to the image forming apparatus 1 as the cartridge 12, the attached cartridge is replaced with the dedicated cartridge. In step S610, based on the dedicated CRG information stored in the cartridge memory 71, the image forming apparatus 1 (the lock control unit 94) determines whether the cartridges 12 (12Y, 12M, 12C, and 12K) are attached as dedicated cartridges.

Based on the fact that the dedicated cartridges are attached as the cartridges 12 (12Y, 12M, 12C, and 12K), in step S611, the image forming apparatus 1 transmits cartridge information regarding the cartridges 12 to the server 410. The cartridge information includes the serial number, the remaining operating life information, and the dedicated CRG information acquired from the cartridge memory 71.

In step S612, based on the cartridge information received from the image forming apparatus 1, the server 410 confirms whether any of the cartridges 12 (12Y, 12M, 12C, and 12K) attached to the image forming apparatus 1 is a dedicated cartridge. Based on the confirmation, the server 410 starts to provide the service in accordance with the contract concluded with the contract as the user. Specifically, the service provider (the server 410) provides the image forming apparatus 1 corresponding to the contract with a print service based on a fixed fee or a page-basis fee to be charged on the image formations executed using the dedicated cartridge.

In this manner, with the above-described subscription contract concluded, if the remaining toner amount is low, a cartridge (specific type of consumable unit) dedicated to the service provided by the service provider is sent from the service provider to the user.

If the image forming apparatus 1 according to the present exemplary embodiment shifts to the contracted state in which the above-described contract is contracted, in order to enable the dedicated cartridge to be used up until its operating life, the door 52 is locked by the lock mechanism. At this time, an unlocking operation performed on the operation panel 50 included in the image forming apparatus 1 owned by the user allows the user to attach a dedicated cartridge as the cartridge 12. Here, examples of the unlocking operation include a method of entering the serial No of a sent dedicated cartridge, and unlocking based on the match of the serial No, and a method of unlocking by entering a password issued by the service provider. Avoiding unlocking at a timing other than a required timing in this manner prevents an unnecessary cartridge replacement, allowing the user with a contract concluded to use a dedicated cartridge alone.

### Processing Procedure for Locking Door

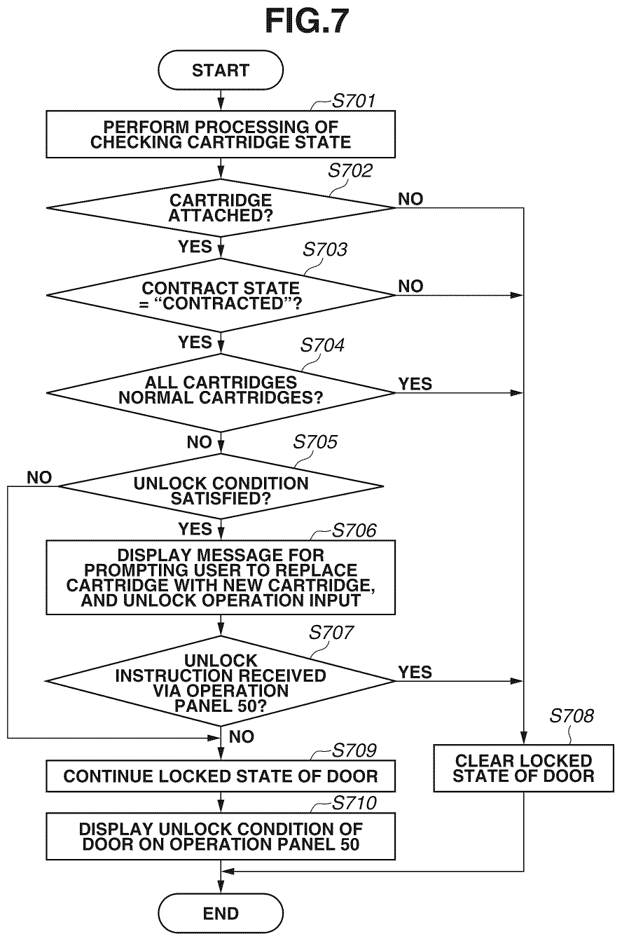

FIG. 7 is a flowchart illustrating an example of a procedure of processing for locking the door 52 on the image forming apparatus 1 according to the present exemplary embodiment. If the power of the image forming apparatus 1 is turned on, or the door 52 is closed, the control unit 60 starts the processing in the procedure in FIG. 7. In the processing, the control unit 60 locks the door 52 using the lock mechanism in order to restrict the removal of the cartridge 12 from the image forming apparatus 1, and clears the locked state depending on the condition.

In step S701, the lock control unit 94 performs processing of checking the state of the cartridge 12. Specifically, the lock control unit 94 loads information (refer to FIG. 11A and FIG. 11B) stored in the cartridge memory 71 onto the RAM 83, and checks the state of the cartridge 12 based on the loaded information.

After the check processing of the cartridge 12 is completed, in step S702, the lock control unit 94 determines whether all the cartridge 12 (the cartridges 12Y, 12M, 12M, and 12C) are attached to the image forming apparatus 1. The attachment of each cartridge 12 is detected based on an output of a detection sensor (not illustrated) provided at an attachment portion (on the image forming apparatus 1) to which the corresponding cartridge 12 is attached, for example. Further, the attachment of each cartridge 12 can be detected based on an output to the control unit 60 from a detection sensor (not illustrated) mounted on the cartridge 12.

If the lock control unit 94 determines that all the cartridges 12 are attached (YES in step S702), the processing proceeds to step S703. If at least one of the cartridges 12 is not attached (NO in step S702), the processing proceeds to step S708. In step S708, the lock control unit 94 unlocks the door 52, and ends the processing. In ending the processing, the lock control unit 94 can notify the user that the cartridge 12 is not attached in a message displayed on the operation panel 50, for example. The lock control unit 94 can prompt the user to attach the unattached cartridge 12 to the image forming apparatus 1.

Next, in step S703, based on information (contract state) stored in the main body memory 72, the lock control unit 94 determines whether a contract state regarding the provision of the above-described service by the service provider is a contracted state. If the lock control unit 94 determines that the contract state is “contracted” (YES in step S703), the processing proceeds to step S704. If the contract state is “uncontracted” (NO in step S703), the processing proceeds to step S708. In step S708, the lock control unit 94 unlocks the door 52, and ends the processing.

### Case Where Contract State Is “Contracted”

In step S704, the lock control unit 94 determines whether the cartridges 12 (the cartridges 12Y, 12M, 12M, and 12C) are dedicated to the service based on the contract. The determination is made based on whether dedicated CRG information stored in the cartridge memory 71 of each cartridge 12 includes “TRUE”. If the lock control unit 94 determines that all the cartridges 12 are normal cartridges (YES in step S704), the processing proceeds to step S708. In step S708, the lock control unit 94 unlocks the door 52, and ends the processing. Otherwise (NO in step S704), the processing proceeds to step S705.

In step S705, the lock control unit 94 determines whether the clearance condition for clearing the locked state of the door 52 (unlock condition) is satisfied. If the lock control unit 94 determines that the unlock condition is satisfied (YES in step S705), the processing proceeds to step S706. If the unlock condition is not satisfied (NO in step S705), the processing ends.

In the present exemplary embodiment, the remaining operating life value of at least any of the cartridges 12Y, 12M, 12C, and 12K is set by the unlock condition to be equal to or smaller than an unlock threshold value. For this reason, if the lock control unit 94 determines that the remaining operating life value of at least any of the cartridges 12 is equal to or smaller than the unlock threshold value (YES in step S705), the processing proceeds to step S706. Otherwise (NO in step S705), the processing ends. As described above, based on information stored in the cartridge memory 71 of each cartridge 12, the lock control unit 94 acquires the remaining operating life value of the cartridge 12, stores the acquired remaining operating life value into the main body memory 72, and uses the remaining operating life value. In addition, the lock control unit 94 reads the unlock threshold value stored in the cartridge memory 71 of each cartridge 12, and uses the read unlock threshold value in the determination in step S705.

In step S706, the lock control unit 94 displays a message for prompting the user to replace the cartridge 12 with a new cartridge, the cartridge 12 of which the remaining operating life value is determined to be equal or smaller than the unlock threshold value (the cartridge 12 of which the unlock condition is satisfied), and the input of an unlocking operation on the operation panel 50. Here, input examples of the unlocking operation include a method of entering the serial No of a dedicated cartridge sent, and unlocking based on the match of the serial No, and a method of unlocking by entering a password issued by the service provider.

In step S707, the lock control unit 94 checks whether an unlock instruction is issued via the operation panel 50. If an unlock instruction is issued (YES in step S707), the processing proceeds to step S708. In step S708, the lock control unit 94 unlocks the door 52, and ends the processing. If no unlock instruction is issued (NO in step S707), the processing proceeds to step S709. In step S709, the lock control unit 94 continues the locked state of the door 52. Furthermore, in step S710, the lock control unit 94 displays a message indicating that the door 52 is locked (indicating that the lock mechanism is brought into the restriction state), on the operation panel 50, and ends the processing. In this manner, the notification to the user that the door 52 is locked allows the user to recognize that the cause of the state is not failure of the image forming apparatus 1 even if the door 52 becomes unopenable.

In this manner, if at least one cartridge 12 (consumable unit) attached to the image forming apparatus 1 is a dedicated cartridge (specific type of consumable unit), the lock control unit 94 brings the lock mechanism of the door 52 into the locked state (restriction state). Then, if any of the cartridges 12 comes near its operating life, the user performs a predetermined operation from the operation panel 50, and then the lock control unit 94 clears the locked state. The lock control unit 94 can display the clearance condition for clearing the locked state (restriction state) of the door 52 on the operation panel 50 together with the above-described message. In this case, the lock control unit 94 displays a message, for example, indicating that “the door is locked. The lock of the door is cleared if the remaining operating life of the cartridge is 5% or less.”, on the operation panel 50. This configuration allows the user to recognize a timing at which the door 52 opens.

As described above, the image forming apparatus 1 according to the present exemplary embodiment includes a lock mechanism of the door 52 that restricts the removal of a consumable unit from the image forming apparatus 1 in a state in which the consumable unit (cartridge) is detachably attached to the image forming apparatus 1. The control unit 60 (the lock control unit 94) performs a control of switching the state of the lock mechanism between a restriction state (locked state) in which the removal of the consumable unit is restricted, and a non-restriction state (unlocked state) in which the removal of the consumable unit is not restricted. The control unit 60 (the lock control unit 94) determines whether the state is a state (first state) in which a service using a specific type of a consumable unit provided by a service provider is contracted. Then, in the state (first state) in which a service is contracted, the lock mechanism is brought into the restriction state (locked state) with the specific type of the consumable unit attached to the image forming apparatus 1.

In this manner, in the image forming apparatus 1 to which a plurality of consumable units (the cartridges 12) is attachable, if at least one of attached consumable units is a specific type of consumable unit (dedicated cartridge), the door 52 is brought into the locked state using the lock mechanism. The avoidance of unlocking at a timing other than a required timing in this manner prevents an unnecessary cartridge replacement, allowing a user to use a dedicated cartridge alone with the contract concluded by the user.

In the present exemplary embodiment, an example is described in which a consumable unit detachable from the image forming apparatus 1 is a process cartridge (the cartridge 12), but the consumable unit of the present exemplary embodiment can be another consumable unit, such as a toner container. In addition, a plurality of consumable units (the cartridges 12) can be attached to the image forming apparatus 1 according to the present exemplary embodiment, but the image forming apparatus 1 can include only one consumable unit (the cartridge 12) attached to it (i.e., monochrome image forming apparatus). In this case, in the contracted state (first state), the control unit 60 (the lock control unit 94) can bring the lock mechanism into the restriction state (locked state) when a consumable unit attached to the image forming apparatus 1 is a specific type of consumable unit. On the other hand, when a consumable unit attached to the image forming apparatus 1 is not a specific type of consumable unit in the contracted state, the control unit 60 (the lock control unit 94) can bring the lock mechanism into the non-restriction state (unlocked state). This configuration, similarly to an image forming apparatus to which a plurality of consumable units (the cartridges 12) is attachable, provides high usability in the replacement of the consumable units.

In a second exemplary embodiment, the description will be given of an example of permitting and carrying out the clearance of a lock mechanism of a door by performing the authentication of a dedicated cartridge sent by a service provider via the server 410, in place of a cartridge unlocking operation performed by the user via the operation panel 50. Hereinafter, the components similar to those in the first exemplary embodiment are assigned the same reference numerals, and the redundant description will be omitted.

In the present exemplary embodiment, when a remaining toner amount of the image forming apparatus 1 is low, a low remaining toner amount information notification and a cartridge sending request are automatically issued from the image forming apparatus 1 to the server 410.

A service provider sends a cartridge dedicated to a service that is filled with toner to the user, and the user continues printing.

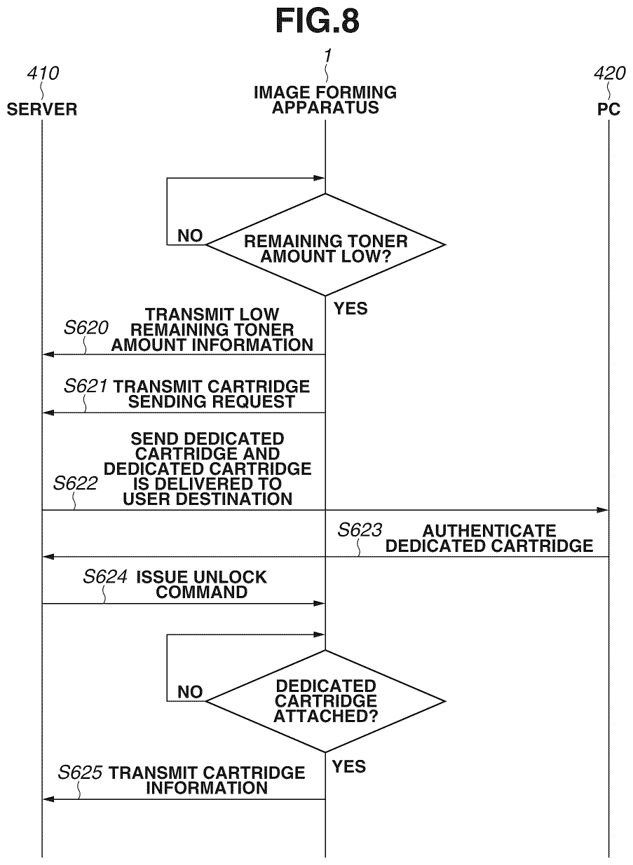

Next, a sequence of processing to be executed when a remaining toner amount with a subscription contract made is low will be described with reference to FIG. 8.

With the print service illustrated in FIG. 6 provided, the image forming apparatus 1 determines whether the remaining toner amount is low while performing printing. If the image forming apparatus 1 determines that a remaining toner amount is low, in step S620, the image forming apparatus 1 transmits low remaining toner amount information to the server 410. Furthermore, in step S621, the image forming apparatus 1 issues a cartridge send request to the server 410.

In step S622, the service provider sends a dedicated cartridge filled with toner due to the low remaining toner amount. If the dedicated cartridge delivered from the service provider arrives at the image forming apparatus 1, before the dedicated cartridge is attached to the image forming apparatus 1, in step S623, the user enters the serial number of the dedicated cartridge sent on the PC 420. The PC 420 notifies the server 410 that the dedicated cartridge is acquired, and the server 410 accordingly performs an authentication based on the serial number. The server 410 has confirmed that the cartridge has arrived at a user destination, and in step S624, the server 410 issues an unlock command to the image forming apparatus 1, and causes a state in which the cartridge of which the remaining toner amount is low can be removed and the sent cartridge can be attached.

The user attaches the dedicated cartridge to the image forming apparatus 1. In response to the attachment of the dedicated cartridge as the cartridges 12 (12Y, 12M, 12C, and 12K), in step S625, the image forming apparatus 1 transmits cartridge information regarding the cartridge 12 to the server 410. The cartridge information includes the serial number, remaining operating life information, and dedicated cartridge information acquired from the cartridge memory 71.

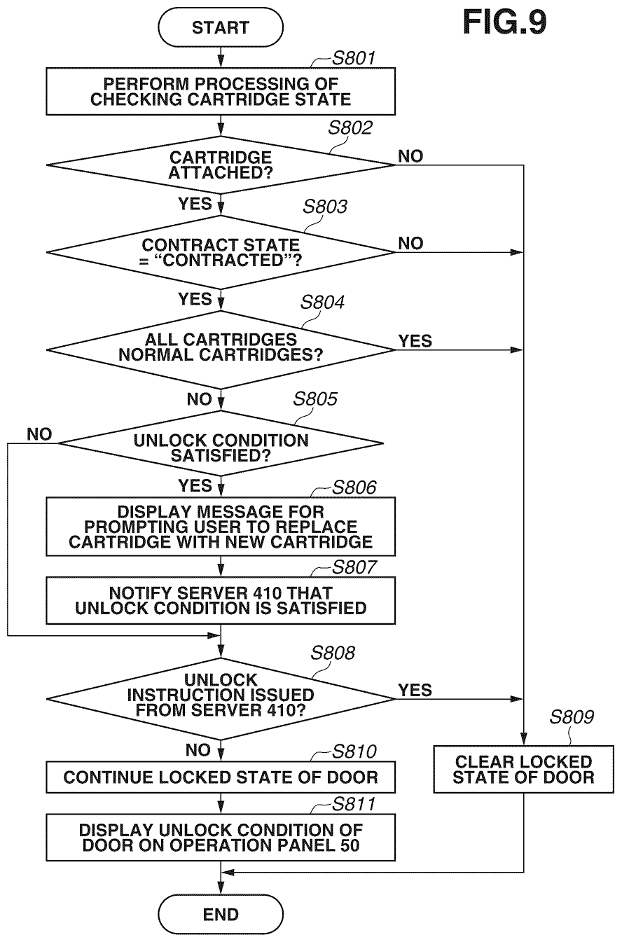

FIG. 9 is a flowchart illustrating an example a procedure of processing for locking the door 52 on the image forming apparatus 1 according to the present exemplary embodiment. If the power of the image forming apparatus 1 is turned on, or the door 52 is closed, the control unit 60 starts the processing in the procedure in FIG. 9. In the processing, the control unit 60 locks the door 52 using the lock mechanism in order to restrict the removal of the cartridge 12 from the image forming apparatus 1, and clears the locked state depending on the condition.

In step S801, the lock control unit 94 performs processing of checking the state of the cartridge 12. Specifically, the lock control unit 94 loads information (refer to Tables 1 and 2) stored in the cartridge memory 71 onto the RAM 83, and checks the state of the cartridge 12 based on the loaded information.

If the check processing of the cartridge 12 is completed, in step S802, the lock control unit 94 determines whether all the cartridges 12 (the cartridges 12Y, 12M, 12M, and 12C) are attached to the image forming apparatus 1.

If the lock control unit 94 determines that all the cartridges 12 are attached (YES in step S802), the processing proceeds to step S803. If at least one of the cartridges 12 is not attached (NO in step S802), the processing proceeds to step S809. In step S809, the lock control unit 94 unlocks the door 52, and ends the processing.

Next, in step S803, based on information (contract state) stored in the main body memory 72, the lock control unit 94 determines whether a contract state regarding the provision of the above-described service by the service provider is a contracted state. If the lock control unit 94 determines that the contract state is “contracted” (YES in step S803), the processing proceeds to step S804. If the contract state is “uncontracted” (NO in step S803), the processing proceeds to step S809. In step S809, the lock control unit 94 unlocks the door 52, and ends the processing.

### Case Where Contract State Is “Contracted”

In step S804, the lock control unit 94 determines whether the cartridges 12 (the cartridges 12Y, 12M, 12M, and 12C) are cartridges dedicated to the service based on the contract. If the lock control unit 94 determines that all the cartridges 12 are normal cartridges (YES in step S804), the processing proceeds to step S809. In step S809, the lock control unit 94 unlocks the door 52, and ends the processing. Otherwise (NO in step S804), the processing proceeds to step S805.

In step S805, the lock control unit 94 determines whether a clearance condition for clearing the locked state of the door 52 (unlock condition) is satisfied. If the lock control unit 94 determines that the unlock condition is satisfied (YES in step S805), the processing proceeds to step S806. If the unlock condition is not satisfied (NO in step S805), the processing proceeds to step S808.

In step S806, the lock control unit 94 displays, on the operation panel 50, a message for prompting the user to replace the cartridge 12 with a new cartridge, the cartridge 12 of which the remaining operating life value is determined to be equal or smaller than the unlock threshold value (the cartridge 12 of which the unlock condition is satisfied).

In step S807, the lock control unit 94 notifies the server 410 that the unlock condition has been satisfied.

In step S808, the lock control unit 94 checks whether an unlock instruction is issued from the server 410. If an unlock instruction is issued (YES in step S808), the processing proceeds to step S809. In step S809, the lock control unit 94 unlocks the door 52, and ends the processing. If no unlock instruction is issued (NO in step S808), the processing proceeds to step S810. In step S810, the lock control unit 94 continues the locked state of the door 52, further displays a message indicating that the door 52 is locked (indicating that the lock mechanism is brought into the restriction state) on the operation panel 50, and ends the processing.

As a second example of the second exemplary embodiment, the description will be given of an example of temporarily clearing a lock mechanism of a door to eliminate the time during which the user cannot execute printing, if the user performs printing by a large amount using normal cartridges because a dedicated cartridge cannot be delivered in time.

In the present exemplary embodiment, when a remaining amount of toner in the image forming apparatus 1 is low, a low remaining toner amount information notification and a cartridge sending request are automatically issued from the image forming apparatus 1 to the server 410. Then, while the cartridge sending request is issued, the door lock is cleared. This enables the user to temporarily use a normal cartridge. The service provider sends a cartridge dedicated to the service that is filled with toner to the user. The user can consequently continue printing until the dedicated cartridge arrives.

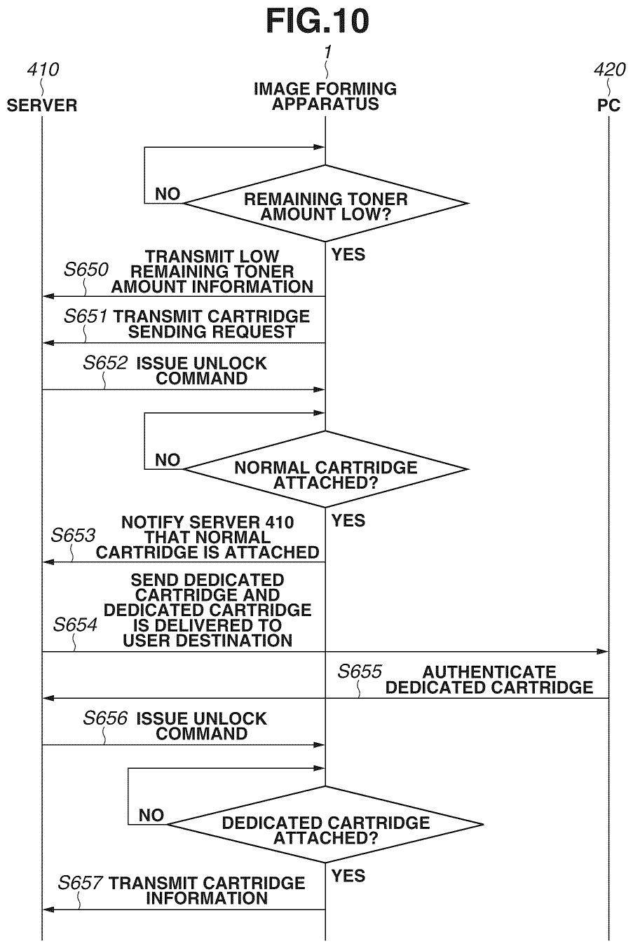

Next, a sequence of processing executed when a remaining toner amount is low with a subscription contract made will be described with reference to FIG. 10. With the print service illustrated in FIG. 6 provided, the image forming apparatus 1 determines whether a remaining toner amount is low while performing printing. If the image forming apparatus 1 determines that a remaining toner amount is low, in step S650, the image forming apparatus 1 transmits low remaining toner amount information to the server 410. Furthermore, in step S651, the image forming apparatus 1 issues a cartridge sending request to the server 410.

Next, in step S652, the server 410 issues an unlock command to the image forming apparatus 1 at the timing of the cartridge sending request, when the user becomes able to replace the cartridge. Here, if the user attaches not a dedicated cartridge but a normal cartridge, in step S653, the image forming apparatus notifies the server 410 that the normal cartridge is attached.

In step S654, the service provider sends a dedicated cartridge filled with toner. If the dedicated cartridge sent from the service provider arrives at the image forming apparatus 1, before the dedicated cartridge is attached to the image forming apparatus 1, in step S655, the user enters the serial number of the dedicated cartridge transmitted from the PC 420. The PC 420 notifies the server 410 of the serial number, and the server 410 accordingly performs an authentication of the dedicated cartridge. If the server 410 confirms that the cartridge has arrived at the user destination, in step S656, the server 410 accordingly issues an unlock command to the image forming apparatus 1, and causes a state in which a cartridge of which a remaining toner amount is low can be removed, and the sent cartridge can be attached.

The user attaches the dedicated cartridge to the image forming apparatus 1. In response to the attachment of the dedicated cartridge as the cartridge 12 (12Y, 12M, 12C, or 12K), in step S657, the image forming apparatus 1 transmits cartridge information regarding the cartridge 12 to the server 410. The cartridge information includes the serial number, the remaining operating life information, and the dedicated cartridge information acquired from the cartridge memory 71. The flowchart illustrating processing executed by the control unit 60 of the image forming apparatus 1 is the same as the flowchart illustrated in FIG. 9.

In this manner, in the present exemplary embodiment, a user can surely use a cartridge sent by a service provider. This configuration ensures the management of cartridges from a service provider.

In the present exemplary embodiment, a serial No is entered on the PC 420, and information is transmitted to the server 410, but a serial No can be entered via a network-connectable device, such as an information terminal including a smartphone, instead of a PC.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-201641, filed Nov. 29, 2023, which is hereby incorporated by reference herein in its entirety.

What is claimed is:

1. An apparatus to which a plurality of cartridges to be used in image formation on a recording material is attachable, the apparatus comprising:
a lock member configured to lock the plurality of cartridges attached from being removed; and
a control unit configured to switch a state of the lock member between a locked state in which the plurality of cartridges is locked from being removed and an unlocked state in which the lock of the plurality of cartridges from being removed is cleared,
wherein, in a contract state in which a contract of using a specific cartridge delivered from a service provider is made, in a case where at least one of the plurality of cartridges attached is the specific cartridge, the control unit switches the state of the lock member to the locked state, and based on satisfaction of a predetermined unlock condition, switches the state of the lock member to the unlocked state.

2. The apparatus according to claim 1, wherein, in an uncontracted state in which the contract is not made, the lock member is brought into the unlocked state by the control unit.

3. The apparatus according to claim 1,
wherein the cartridges each include a memory storing information indicating the specific cartridge, and
wherein the control unit determines, based on the information in the memory included in each attached cartridge, whether the cartridge is the specific cartridge.

4. The apparatus according to claim 1, further comprising a display unit configured to display a message indicating that the lock member is brought into the locked state.

5. The apparatus according to claim 1, further comprising a display unit configured to display a clearance condition for clearing the locked state, when the lock member is brought into the locked state.

6. The apparatus according to claim 5, wherein the clearance condition is that a remaining operating life value indicating a remaining operating life of the cartridge is equal to or smaller than a threshold value.

7. The apparatus according to claim 6,
wherein the cartridges each include a container storing toner, a photosensitive member on which an electrostatic latent image is to be formed, and a development unit configured to develop the electrostatic latent image formed on the photosensitive member with the toner, and
wherein the control unit acquires the remaining operating life value based on one or more of an accumulated time obtained by accumulating times of rotation of the photosensitive member, an accumulated distance obtained by accumulating distances of movement of a surface of the photosensitive member by the rotation of the photosensitive member, and a remaining toner amount in the toner container.

8. The apparatus according to claim 6,
wherein the cartridge includes a container storing toner, and
wherein the control unit acquires the remaining operating life value based on a remaining toner amount in the toner container.

9. The apparatus according to claim 1, wherein the specific cartridge is a dedicated consumable unit.

10. The apparatus according to claim 1, wherein the contract is a subscription contract with a fixed fee or a page-basis fee to be charged on image formation using the specific cartridge.

11. The apparatus according to claim 1, further comprising a door configured to enable access to a consumable unit attached to the apparatus in an opened state, and disable the access in a closed state,
wherein the lock member locks the door in the closed state.

12. The apparatus according to claim 1, further comprising a storage unit storing information indicating a contract state of the apparatus,
wherein the control unit determines whether the apparatus is in a state in which the contract is made, based on the information stored in the storage unit, and
wherein, in an uncontracted state in which the contract is not made, the control unit shifts the apparatus from the uncontracted state to the contract state in accordance with a notification indicating a start of the contract received from a server apparatus configured to perform communication via a network, and updates the information stored in the storage unit.

13. A system comprising:
an apparatus to which a plurality of cartridges to be used in image formation on a recording material is attachable, the apparatus; and
a server configured to transmit and receive a state of and information about the apparatus,
wherein the apparatus includes:
a lock member configured to lock the plurality of cartridges attached from being removed, and
a control unit configured to switch a state of the lock member between a locked state in which the plurality of cartridges is locked from being removed and an unlocked state in which the lock of the plurality of cartridges from being removed is cleared,
wherein, in a contract state in which a contract of using a specific cartridge delivered from a service provider is made, in a case where at least one of the plurality of cartridges attached is the specific cartridge, the control unit switches the state of the lock member to the locked state, and when a clearance instruction of a restriction unit is issued from the server, switches the state of the lock member to the unlocked state.

14. The system according to claim 13, wherein, in an uncontracted state in which the contract is not made, the lock member is brought into the unlocked state by the control unit.

15. The system according to claim 13,
wherein the cartridges each include a memory storing information indicating the specific cartridge, and
wherein the control unit determines, based on the information in the memory included in each attached cartridge, whether the cartridge is the specific cartridge.

16. The system according to claim 13, wherein the apparatus further includes a display unit configured to display a message indicating that the lock member is brought into the locked state.

17. The system according to claim 13, wherein the apparatus further includes a display unit configured to display a clearance condition for clearing the locked state, when the lock member is brought into the locked state.

18. The system according to claim 13, wherein the specific cartridge is a dedicated consumable unit.

19. The system according to claim 13, wherein the contract is a subscription contract with a fixed fee or a page-basis fee to be charged on image formation using the specific cartridge.

20. The system according to claim 13, wherein the apparatus further includes a door configured to enable access to a consumable unit attached to the image forming apparatus in an opened state, and disable the access in a closed state,
wherein the lock member locks the door in the closed state.
